(19) United States
(12) Patent Application Publication
(10) Pub. No.: US 2008/0071203 A1
(43) Pub. Date: Mar. 20, 2008

(54) Percussive therapy blade

(76) Inventor: Edward Miller, Salem, OR (US)

Correspondence Address: CARL D. CROWELL, P.O. BOX 923, SALEM, OR, 97308-0923, US

(21) Appl. No.: 11/899,755

(22) Filed: Sep. 6, 2007

Related U.S. Application Data
(60) Provisional application No. 60/826,216, filed on Sep. 19, 2006.

(51) Int. Cl. A61H 23/00

(52) U.S. Cl. 601/107

(57) ABSTRACT

A massage head comprised of a contoured edge shaped to conform to and capture specific areas of the human body for use in soft tissue therapy by perpendicular attachment to a vibratory massage appliance. The perpendicular attachment of the massage head provides both surface and deep tissue action in any proportion and the contoured shape of the massage head focuses percussive motion of the vibratory massage appliance on afflicted soft tissues, resulting in enhanced therapeutic effect.

### CROSS REFERENCE TO RELATED APPLICATIONS

This application contains disclosure from and claims the benefit under Title 35, United States Code, §19(e) of the following U.S. Provisional Application: U.S. Provisional Application Ser. No. 60/826,216 Filed Sep. 19, 2006 entitled PERCUSSIVE THERAPY BLADE.

### BACKGROUND

This invention relates to therapeutic massage tools, specifically to a contoured blade head for attachment to a percussive mechanical massage tool specially shaped to the contours of affected regions of a patient's body.

Soft tissues in the human body are tissues, such as skin muscles, fascia tendons, ligaments and lymphatic ducts, which support or connect other structures of the body. Trauma to soft tissues can cause inflammation and the formation of scar tissue. As scar tissue builds, the body's muscles and ligaments have less flexibility and are not able to expand and contract naturally. This causes an afflicted person pain and greatly reduces his or her range of motion. The pain may linger even where the underlying injury has healed. Soft tissue injuries are difficult to treat because soft tissues are covered by skin, consequently it is difficult to determine what damage has occurred.

Scar tissue has commonly been removed by soft tissue therapy. Typically, this therapy involves applying pressure or some other physical force to the afflicted soft tissue. The pressure or force loosens and releases the scar tissue reducing pain and allowing the treated soft tissue to regain its former flexibility.

One way of performing soft tissue therapy is by manually massaging the skin above the affected soft tissue to loosen and release the scar tissue beneath. Manual massage is not the optimal method when it comes to applying the proper amount of pressure because a therapist may apply too much or too little pressure. Too much pressure causes the patient pain while too little pressure is ineffective in releasing scar tissue. In some cases, it may be impossible for a therapist to physically exert the necessary amount of pressure to release hardened scar tissue or for the therapist to manually locate scar tissue below the skin. Manual massage also poses a risk of hand injury to the therapist if performed for extended periods of time.

Another way of performing soft tissue therapy is through the use of a hand tool. U.S. Pat. No. 5,231,977 discloses such a device. The tool is shaped to conform to the contours of the body above the soft tissue to- be treated. A handle is attached to the shaped section of the tool so that a therapist may easily use the tool. This allows a greater amount of pressure to be transferred to the affected parts of the patient's body because the shaped contact section focuses pressure specifically to the areas needing treatment. This loosens scar tissue more effectively than manual massage alone. The shaped section can be manipulated along the skin to pull released scar tissue away from the affected soft tissues. The risk of hand injury to a therapist is reduced in part because the tool covers more of the affected area than the therapist's hands alone could. However, soft tissue therapy with a hand tool still requires a significant exertion of force and suffers the same problem of a manual massage, that of inconsistent pressure inherent in any manual manipulation of the soft tissues. Furthermore, a manual hand tool is limited by the physical limitations and strength of its operating therapist.

These hand tools rely on manual effort to produce the desired effect. Generally, manual massage, with or without a tool, works by sliding pressure across the body. Sliding pressure will release scar tissue; however, a rapid percussive motion may be more effective in releasing scar tissue and promoting healing. The use of percussive motion for massage is frequently employed by massage devices that use electricity to power a vibratory motor. U.S. Pat. No. 6,436,062 discloses a massage appliance where a motor provides vibratory motion to a series of rollers which massage the body. Similarly, U.S. Pat. No. 6,682,496 discloses a deep muscle massage device where a motor vibrates a hollow head containing loose granular material. The granules enhance the kinetic motion of the motor, allowing the device to massage muscles deep within the body. These devices solve the problem of hand strain in manual tools by providing an electrically powered vibration source. These devices also provide a percussive massage that is effective in removing scar tissue. However, these devices are not shaped to conform to particular parts of the human body. Thus, these devices depend on a user incrementally lifting and placing the device on the afflicted soft tissues in order to approximate the contours of particular parts of the human body.

U.S. Pat. No. 6,988,997 discloses a massager with interchangeable massage heads. The user of this device can provide various types of massage by changing the massage head of the device. Once again, the interchangeable heads are not closely contoured to the shape of the human body. As such, the massage provided by this device is not as focused as one from a massage device with a shaped contact section. Where this is the case the massage or therapy is less consistent than where a shaped contact section guides and focuses the massage.

In addition, the mentioned percussive and vibrating devices create displacement of tissue horizontally or vertically across the body part, but not both.

What is desired and herein disclosed is a removable massage head for a powered vibratory massage appliance shaped to conform to and capture various parts of the human body. The shaped head has rigid contoured edges corresponding to different parts of the body and may be selectively used to focus therapy on a particular part of the body. The shaped head also guides the massage along the body eliminating the inconsistency found in manual endeavors. The risk of hand injury to the therapist is greatly reduced because the shaped edge reduces the surface area contacting the patient and thus reduces the total pressure needed to effect beneficial use. Therapist fatigue and injury is further lessened through the use of a powered percussive or vibratory massage appliance. Significantly less physical exertion is required, resulting in the ability to perform more massages without strain. The head is contoured to permit the wave created by the therapeutic use of a massage appliance to loosen and release hardened or deeply embedded scar tissue on which manual massage has little or no effect. Lastly, the working edge of the head is generally used perpendicular or at an incline to the direction of travel or fiber of the tissue treated and long enough to allow for either horizontal or vertical displacement of tissue. The degree of perpendicularity of the working edge allows delivery of percussive waves such as compression waves to surface tissue, deep tissue or both proportionally.

### SUMMARY OF THE INVENTION

The subject of this invention is a, removable, contoured massage head having a contoured edge or edges specifically contoured to the shape of various parts of the human body. The contoured massage head may be rigid and comprised of hard plastic, metal or any other material that is rigid or rigid with some elasticity or flexibility. The contoured massage head is designed to have an attachment means, options may include a hole that runs through the contoured massage head, stabilization dimples, and a means of rotation. The stabilization dimples add additional friction and will help prevent the shifting of the massage head once it is attached to a powered percussive massage appliance through an attachment mechanism.

The attachment mechanism may also allow the contoured massage head to be rotated and changed so that the proper contour is used on a particular area of the body. The attachment mechanism may include a thrust bearing that will allow the massage head to be rotated up to 360° after attachment to a percussive device, thus allowing practitioners different approach angles to treatment areas.

The contoured edge may consist of any combination of concave sections, convex sections and linear sections. The contoured edge transfers, captures, and focuses the percussive motion of the massage appliance to specific soft tissue areas of the body by guiding the massage appliance along the surface of the body. This percussive motion may deliver a therapeutic wave such as a compression wave, vibratory wave or massage wave that loosens and releases scar tissue within a patient's soft tissues.

This invention addresses the issues of inadequate force and excessive strain of manual massage. A powered massage appliance is capable of consistently providing enough percussive force, which generates one or a combination of compression, vibratory and massage waves to loosen scar tissue without excessive strain on a therapist even where the scar tissue has hardened or is deep within the body. The therapist need only exert sufficient force to keep the appliance in contact with the patient. Thus, there is little strain because the appliance provides the percussive force for the massage. The contoured massage head also helps the therapist move the massage appliance across the correct parts of the body ensuring proper application of soft tissue therapy.

### BRIEF DESCRIPTION OF THE DRAWINGS

FIG. 1 is a front view of the contoured massage head.

FIG. 2 is a perspective view of the contoured massage head from below.

FIG. 3 is a perspective view of the attachment knob.

FIG. 4 is a side view of the contoured massage head attached to a percussive device.

FIG. 5 is a perspective view of an alternate embodiment of a contoured massage head.

### PREFERRED EMBODIMENT OF THE INVENTION

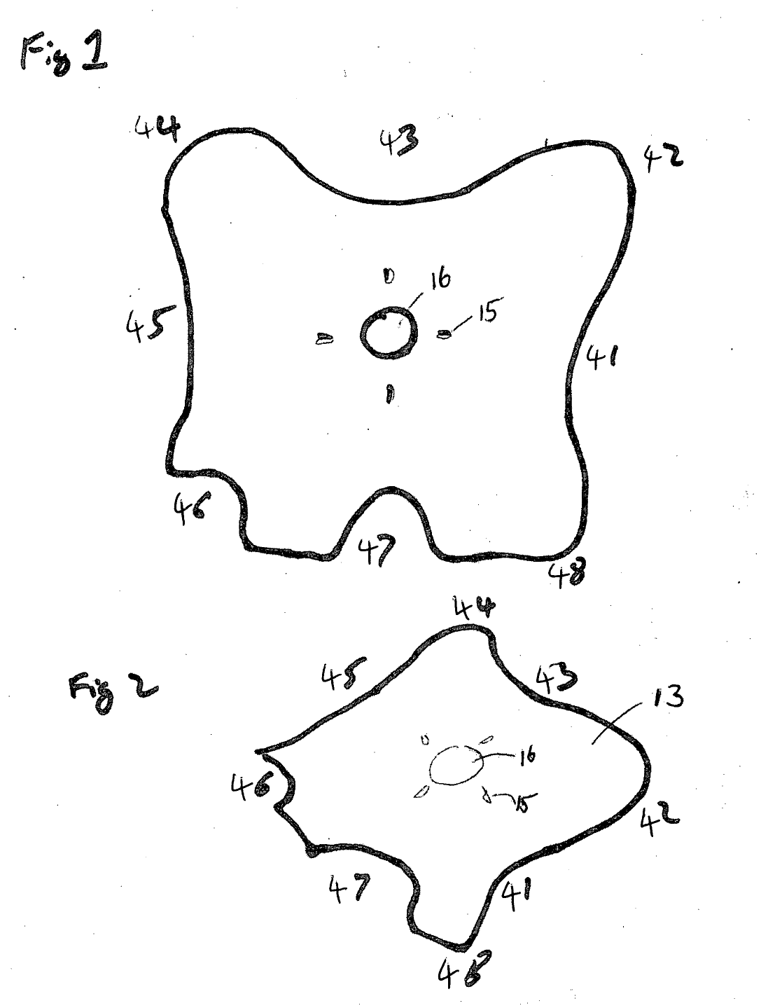

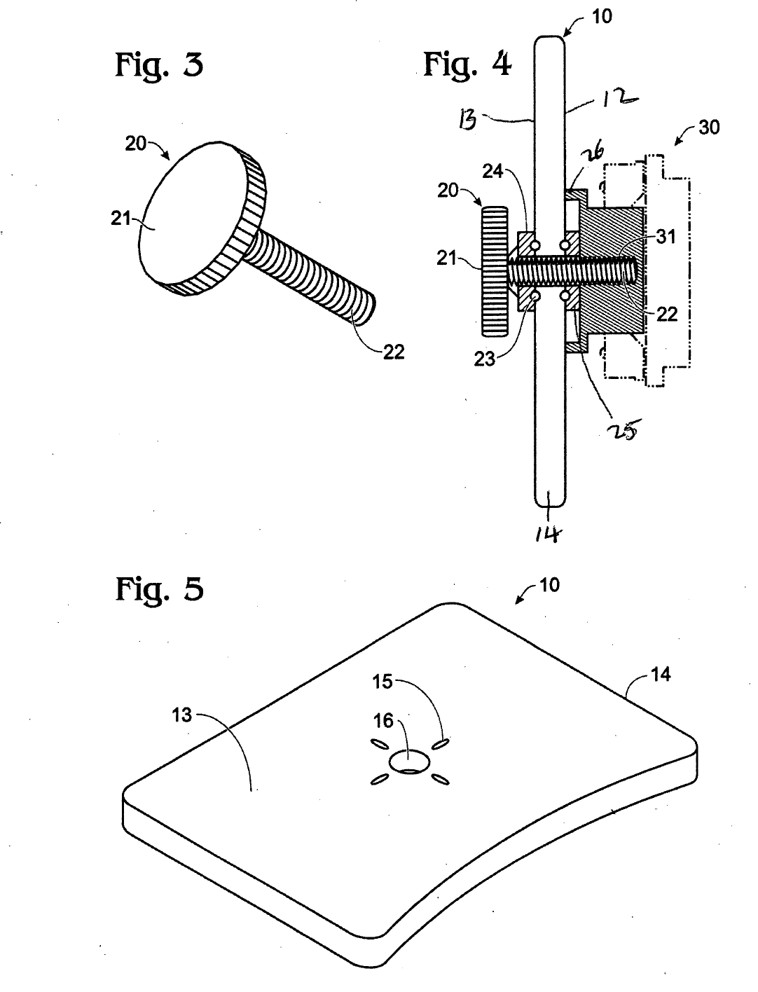

FIGS. 1-4 depict the preferred embodiment. In the preferred embodiment, the contoured massage head 10 is comprised of a rigid material that can be made of hard plastic or any material that is rigid or rigid with some elasticity or flexibility. The contoured massage head 10 is substantially planar, having a top surface 13, a bottom surface 12 substantially parallel to the top surface 13, and a perimeter 14. Viewing the top surface 13, and necessarily the bottom surface 12, horizontally, the perimeter 14 is a substantially vertical edge that connects the edges of the top surface 13 to the edges of bottom surface 12. Sections of the perimeter 14 are shaped to create a series of contoured edges 41, 42, 43, 44, 45, 46, 47 and 48. The contoured edges 41-48 correspond to the surface of any area of the human body and are formed of a series of concave sections 43, 45, 46, and 47 and convex sections 41, 42, 44, and 48.

The contours of the contoured edges 41-48 are shaped so that the various curves substantially match the curves of the area of the body. For example, contoured edge 41 may be the optimal choice for flat or slightly convex tissue. Contoured edge 42 may be applied at 45-90 degree angle on the levator scapula for maximal release of the tissues there. Contoured edge 43 may be the best choice to negate any thoracic outlet problems. Contoured edge 44 due to its smaller size may be used to treat carpal tunnel, Oppenens Pollicis, and Peronei. Contoured edge 45 may be used anywhere with larger tissues such as the quadriceps, hamstrings, and gluts. Contoured edge 46 may fit over flexor tendons, and the Achilles tendons. Contoured edge 47 may be used on the arms when working with golfer's elbow. Contoured edge 48 may be used on the hands and feet to simulate acupuncture points.

The contoured edges may also have a blade or knife like edge to further reduce the surface area and increase the effective therapeutic wave formed and the precision of contact with target tissue providing a more concentrated therapeutic wave such as a compression wave, vibratory wave or massage wave intended to treat and affect targeted tissue and provide other therapeutic value, yes without the need for added pressure.

In the preferred embodiment, the top surface 13 and bottom surface 12 are substantially planar. An attachment means 16 allows the contoured massage head 10 to be attached to a percussive massage device 30. The attachment means 16 also allows contoured massage heads 10 to be changed or rotated so the appropriate contoured edge 41-48 can be used on a particular part of the body. Preferably, the attachment means 16 is a round hole through the contoured massage head 10, made substantially perpendicular to the bottom surface 12. An attachment knob 20 having a knob head 21 and a threaded rod 22 secures the contoured massage head 10 to the massage appliance 30.

To attach the contoured massage head 10, the threaded rod 22 of the attachment knob 20 is passed through a thrust bearing 24 and the attachment means 16 to meet the threaded connector 31, washer 25 and piston 26 of the massage appliance 30. When turned clockwise the inclined planes which make up the threads on the threaded connector 31 and threaded rod 22, generate pressure. This pressure frictionally secures the contoured massage head 10 to the massage appliance 30 by asserting force onto the piston 26 and washer 25. The knob head 21 is sized larger than the attachment means 16 to hold the contoured massage head 10 in place. The stabilizing dimples 15 acts as stabilizers used to intersect with points on the washer 25, and trust bearing 24 to create more fiction and help prevent unintended rotation of the massage head 10. Due to the trust bearing 24 located between knob 21 and the massage head 10, the massage head 10 may be rotated 360° without loosening the attachment knob 20. The contoured massage head need only be rotated so that the proper contoured edge is in contact with the desired area of the body. The versatility of the 360° rotation of the massage head also allows practitioners to apply the same contoured edge in different angles.

FIG. 5 depicts an alternative embodiment, wherein the perimeter of the contoured massage head is substantially rectangular or square. In yet another alternate embodiment, the substantially rectangular massage head has one or more contoured edges that are shaped into one or more of the four sides of the contoured massage head to allow the contoured massage head to be effectively used on various parts of the body.

Throughout the specification the aim has been to describe the invention without limiting the invention to any one embodiment or specific collection of features. Persons skilled in the relevant art may realize variations from the specific embodiment that will nonetheless fall within the scope of the invention. For example, the contoured massage head 10 can be connected in an alternative way to a percussive massage device 30, the contoured massage head 10 does not have to be planer, and the shape of the contoured massage head is not limited to the previously described embodiments. Additionally, the attachment means 16 does not have to be a circular hole but can be any shape and can be located anywhere through the contoured massage head. The dimples 15 are optional and need not be limited by its size or shape as long as it is used to add additional friction between the contoured massage head 10 and the massage appliance 30. The material of the contoured massage head need not be limited to hard plastic but can be of any material that is rigid or rigid with some elasticity and flexibility. The massage head need not be detachable but may contain a built in or permanently attached percussive wave or motion generating device. The massage head 10 may be attached to alternative forms of fixed or variable speed motorized devices and is not limited to a pure percussive device.

Accordingly, the scope of the invention should be determined not by the embodiments illustrated, but by the appended claims and their legal equivalents.

I claim:

1. A contoured massage head for generation of a therapeutic wave comprising:
a rigid material;
a top surface;
a bottom surface;
a perimeter;
an attachment means;
wherein said perimeter has a contoured edge.

2. The contoured massage head of claim 1 wherein said contoured edge is shaped to conform to an area of the human body.

3. The contoured massage head of claim 1 wherein said rigid material is substantially rigid with some elasticity.

4. The contoured massage head of claim 1 wherein said top surface is substantially planar.

5. The contoured massage head of claim 1 wherein said bottom surface is substantially planar.

6. The contoured massage head of claim 1 wherein said attachment means is comprised of a hole through said contoured massage head, an attachment knob, a means of stabilization and a means of rotation.

7. The contoured massage head of claim 6 wherein said means of stabilization consist of an at least one stabilization dimple.

8. The contoured massage head of claim 6 wherein said means of rotation contains an at least one trust bearing.

9. The contoured massage head of claim 1 wherein said perimeter has an at least two distinct convex sections.

10. The contoured massage head of claim 1 wherein said perimeter has an at least two distinct concave sections.

11. The contoured massage head of claim 1 wherein said perimeter is substantially square.

12. The contoured massage head of claim 1 wherein said perimeter has an at least one substantially linear section.

13. A percussive therapeutic device for generation of a therapeutic wave comprising:
A contoured massage head comprised of
a rigid material;
a top surface;
a bottom surface;
a perimeter;
an attachment means;
wherein said perimeter has a contoured edge
wherein said contoured massage head is affixed by said attachment means to a percussive massage device that allows both horizontal and vertical tissue displacement proportionally.

14. The percussive therapeutic device of claim 13 wherein said contoured edge is shaped to conform to an area of the human body.

15. The percussive therapeutic device of claim 13 wherein said rigid material is substantially rigid with some elasticity.

16. The percussive therapeutic device of claim 13 wherein said bottom surface is substantially planar.

17. The percussive therapeutic device of claim 13 wherein said top surface is substantially planar.

18. The percussive therapeutic device of claim 13 wherein said attachment means is comprised of a hole through said contoured massage head, an attachment knob, a means of stabilization, and a means of rotation.

19. The percussive therapeutic device of claim 18 wherein said means of stabilization consist of an at least one stabilization dimple.

20. The percussive therapeutic device of claim 18 wherein said means of rotation consist of an at least one trust bearing.

21. The percussive therapeutic device of claim 13 wherein said perimeter has at least two distinct convex sections.

22. The percussive therapeutic device of claim 13 wherein said perimeter is substantially square.

23. The percussive therapeutic device of claim 13 wherein said perimeter has at least two distinct concave sections.

24. The percussive therapeutic device of claim 13 wherein said perimeter has at least one substantially linear section.
